(19) United States
(12) Patent Application Publication
(10) Pub. No.: US 2003/0212841 A1
(43) Pub. Date: Nov. 13, 2003

(54) Method and apparatus of controlling an operational mode of a USB device

(76) Inventor: Ju-Yung Lin, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,777

(22) Filed: May 12, 2002

(51) Int. Cl. G06F 13/12

(52) U.S. Cl. 710/62

(57) ABSTRACT

A method and related hardware for changing operational modes of a Universal Serial Bus (USB) device includes having a detection circuit monitor the connection status of the device port or ports of the USB device. The detection circuit monitors each device port for the presence of a host computer system or a terminator. A control circuit utilizes the output from the detection circuit to determine the correct operational mode for the USB device. The control circuit initiates a USB function reset when changing the mode of the device, such that the host computers can detect the new mode.

### BACKGROUND OF INVENTION

1. Field of the Invention

The present invention relates to a Universal Serial Bus (USB) device, and more specifically, to a method and related device for controlling the operational mode of a USB device.

2. Description of the Prior Art

The USB device standard has recently become widely accepted in the computer industry. Virtually all personal computers manufactured today have at least one USB host port. Devices such as input peripherals, printers, and network linkers to name just a few, are now commonly and sometimes exclusively available in the USB standard. Additionally, multifunction USB devices, with two or more distinct functions, are also available.

USB devices are essentially slave devices that depend on a host PC to control them. When a user connects a USB device to a host, the host detects the new device. The first thing that the host does after device detection is to send a get device descriptor command to the USB device. The new device responds by sending its own device descriptor, a unique description of what the device is, to the host. The host PC then knows what device driver and communication protocol to use. Certain basic devices such as keyboards and storage systems have drivers that are built into the operating system of the PC, while other devices require specialized software from the device manufacturer.

Please refer to FIG. 1, which is a block diagram of a multifunction USB device 10 according to the prior art technology. For the purposes of this explanation, the device 10 shown is a network linker for connecting two host PCs in such a way that the PCs can share information. The device 10 has a single operational mode with two functions (also termed “configurations”), which is indicated by a single device descriptor. This device descriptor (and the handshaking which occurs after it) indicates that the device simultaneously supports both functions (or configurations), and hence simultaneously requires two device drivers, one respectively for each function. Function A is a linking function where the device connects two hosts for information exchange, and function B is a storage function where a host can store data in the device 10. The desired function is addressed by a PC using an appropriate device driver and command, and both computers must have the device driver installed in order to use the device 10. The device driver is supplied on a CD or floppy disk and is installed on the host PCs prior to or during connecting the device 10.

The device 10 has a first USB device port 12 and a second USB device port 16. The USB ports 12 and 16 are typical male USB ports, each at the end of a USB cable, and connect to the host PCs through female USB host ports located on the PCs. The USB ports 12 and 16 contain circuits required to process the input and output signals of the USB device 10. As the USB device 10 has two independent functions, two FIFOs are required for each USB port. Accordingly, the USB port 12 is connected to two FIFOs 14A and 14B, and the USB port 16 is connected to two FIFOs 18A and 18B. The FIFOs 14A, 14B, 18A, 18B are connected to a control circuit 20 and relay digital information back and forth between the control circuit 20 and the USB ports 12 and 16. A particular FIFO 14A, 14B, 18A, 18B is used during operation depending on what function the device 10 is performing. The control circuit 20 comprises all of the electronics, chips, and related components required for the device 10 to perform as intended.

Another embodiment of prior art technology is taught by Rafferty et al. in U.S. Pat. No. 6,141,719, which is included herein by reference. Rafferty shows how a plurality of USB devices can be connected to one host PC, and a particular USB device can be activated by a switching procedure. The switching procedure described, however, is a user-triggered event. Furthermore, the additional hardware required to build such a switch becomes an added cost. There is no way to change the actual operational mode of the USB devices described by Rafferty et al., except by simply connecting or disconnecting them to a host computer so that the devices are either active or inactive.

The prior art method of using multifunction USB devices is inconvenient, as it requires the installation of both device drivers when perhaps only a single function is desired. Further, the prior art method potentially includes expensive redundant components, such as extra FIFOs, that do not add functionality if only a single function is used or desired.

### SUMMARY OF INVENTION

It is therefore a primary objective of the claimed invention to provide a method of controlling an operational mode of a Universal Serial Bus (USB) device to solve the problems of the prior art.

According to the claimed invention, a USB device comprises at least one USB device port, a detection circuit, and a control circuit, and receives power either from a host or from a separate power supply. The USB device has at least two operational modes and responds to get descriptor commands issued by a host according to the mode that the device is in. Utilizing the detection and control circuits, the USB device is able to change operational modes depending on the number of USB device ports receiving a voltage provided by a host, and whether or not a terminator is connected to a USB device port. The changing of operational modes is completed by a USB function reset operation.

It is an advantage of the claimed invention that the USB device can automatically switch operational modes with minimal user effort. Further advantages of the claimed invention include that the USB device can provide functionality without manual host software installation, and that additional hardware is not required to support different independent operational modes. Further, the claimed device requires only one pair of FIFO buffers, and thus is less expensive to manufacture.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a multifunction USB device according to the prior art.

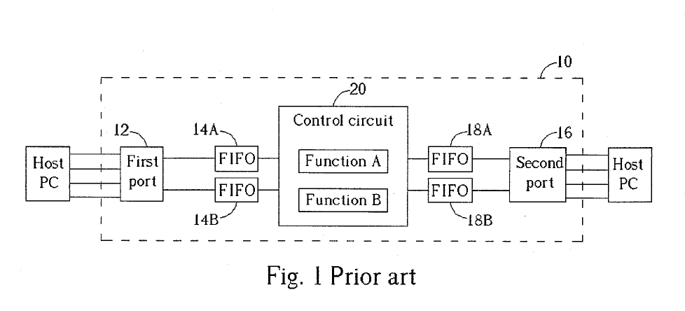

FIG. 2 is a block diagram of a present invention multifunction USB device.

FIG. 3 is a perspective view of a USB device port and a terminator according to the present invention.

FIG. 4 is a block diagram of the terminator shown in FIG. 3 connected to a USB device.

FIG. 5 is a perspective view of a USB device port-on a USB device and an alternative terminator design according to the present invention.

### DETAILED DESCRIPTION

The preferred embodiment of the present invention provides a method for switching the operational mode of a multifunction Universal Serial Bus (USB) device. The preferred embodiment will be described referencing two separate USB devices, but the present invention can be applied using any USB device.

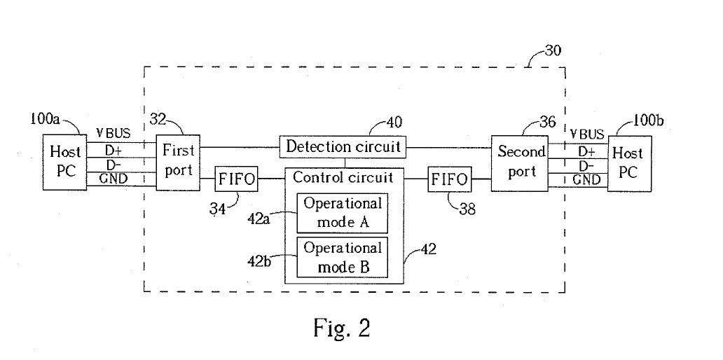

Please refer to FIG. 2, which is a block diagram of a multifunction USB device 30 according to the present invention. It is important to note that the USB device 30 is just that, a device, and not a USB host or hub. The device 30 can connect to one or two host computers using a first USB port 32 and a second USB port 36, which are standard male USB type A device plugs. The device ports 32 and 36 thus respond as USB devices, and not as USB hosts or hubs. The ports 32 and 36 each have the four standard USB contacts consisting of bus power (VBUS), signal (D+ and D−), and ground (GND). The ports 32 and 36 are connected to a control circuit 42 through FIFOs 34 and 38, respectively. The control circuit 42 provides the actual functions of the device 30, using two operational modes A 42a and B 42b. The ports 32 and 36 are also both connected to a detection circuit 40. The detection circuit 40 senses how many ports 32, 36 are connected to powered USB components, i.e., USB hosts such as personal computers (PCs), by measuring the bus voltage VBUS of each port 32 and 36, and communicates this information to the control circuit 42. For the purposes of this description, the multifunction USB device 30 is assumed to be a host powered high-speed host-to-host network linker in combination with a storage device. That is, operational mode A 42a is a permanent storage device (such as a flash memory stick), whereas operational mode B 42b is a host-to-host linking device. It should be noted that operational modes 42a and 42b offer unique and fully supported functionality so that they represent, in effect, two distinct USB devices in a single housing. The present invention is not limited to the aforementioned two functions, however, and many combinations are possible. For example, a scanner/memory device combination, or a scanner/host-to-host combination, etc. The exact functionality of modes 42a and 42b is simply a design choice, but they should be unique, with respect to the query-response protocol initiated by get descriptor commands issued by a host 100a, 100b, so that each operational mode 42a, 42b requires a corresponding device driver on the host 100a, 100b.

The USB Specification (currently version 2.0) stipulates what happens when the USB device 30 is connected to a host port, and this will only be outlined briefly. When the USB device 30 is plugged into a first USB component, a computer 100a, using the first port 32, the D+ signal line is pulled from ground to high by the device 30. Note that the connection procedures are different for different connection speeds. For high/full speed devices, the D+ signal line is pulled high by a pull-up resistor, and for low-speed devices, the D− signal line is pulled high by a pull-up resistor. As the D+ signal line is monitored by the host PC 100a for a change in voltage, the host PC 100a recognizes that a device has been connected. The USB device 30 will also, at the same time, receive the operating voltage VBUS, typically 5 Volts, from the host PC 100a, and in fact uses the voltage VBUS to pull the D+ signal line high. This is well known in the art and repeated here only for convenience.

In addition to what is outlined in the USB Specification, when connected to the host PC 100a, the present invention USB device 30 conveys the operating voltage VBUS to the detection circuit 40. The detection circuit 40 then determines that only one powered-up host PC is connected to the device 30. It is this host PC 100a, a powered USB component connected to the first USB port 32, that actually provides the electrical power required by the USB device 30 to operate.

After the USB device 30 is connected, the host PC 100a then attempts to identify the device 30 and load the appropriate device driver. The PC 100a does this by sending get descriptor commands to the device 30. Meanwhile, the detection circuit 40 has informed the control circuit 42 that only one host PC is connected. The control circuit 42 then determines that the device 30 is to operate exclusively in mode A 42a, which is a storage mode. The device 30 responds to the get descriptor commands with a device descriptor and configuration descriptor corresponding only to operational mode A 42a. In effect, operational mode 42b is neither indicated nor used. The PC 100a uses the device and configuration descriptor to search for a suitable device driver, and if it fails to find one, the PC 100a prompts the user to supply a device driver. Most new operating systems have a built-in USB storage driver, but some older operating systems, such as Windows 98/95, do not. Thus far, the multifunction USB device 30 has been connected to a single host PC and behaves like a typical single function USB storage device.

When it is desired to switch the device 30 to the operational mode B 42b, the host-to-host network linker mode, the user simply connects the second USB device port 36 to a second USB host component, which in this case is a second PC 100b. The second PC 100b initiates the same standard USB process that the first PC 100a did originally. This time, however, the detection circuit 40 detects, through a second bus voltage VBUS in the second device port 36, that two PCs 100a and 100b are now connected to the device 30. The control circuit 42 responds to this by changing to operational mode B 42b, therefore changing the functionality of the USB device 30.

The changing of the operational mode of the USB device 30 is finalized by a USB function reset. A USB function reset is required because the first host PC 100a, due to the nature of USB communications, cannot detect a mode change. In other words, a PC will only query a USB device regarding the function of the device when the device is plugged in. The USB function may be reset by a control unit in the device by temporarily turning off the D+ pull-up behavior. Note that the disconnect procedure for high/full speed devices includes disconnecting the D+ pull-up resistor, with the procedure for high-speed devices further including removing a 45 Ω resistance from both the D+ and D− signal lines. The disconnect procedure for low-speed devices includes disconnecting the D− pull-up resistor. In effect, a disconnect/connect operation is performed by the device 30 with respect to the first host PC 100a. The first PC 100a, which is still physically connected to the device 30, interprets this reset as the device 30 being physically disconnected and a new unknown device being connected.

After the USB device 30 has performed the disconnect/connect operation with the host PC 100a, both the host PCs 100a and 100b respectively issue a get descriptor commands as before. This time, however, the device 30 returns a device descriptor and configuration descriptor corresponding exclusively to the operational mode B 42b. Operational mode A 42a is neither indicated nor used. As before, the PCs 100a and 100b search for or prompt the user to install the appropriate device driver corresponding to operational mode 42b. The multifunction USB device 30 is now connected to two host PCs and behaves like a typical single function USB host-to-host network linking device (the example functionality of operational mode B 42b).

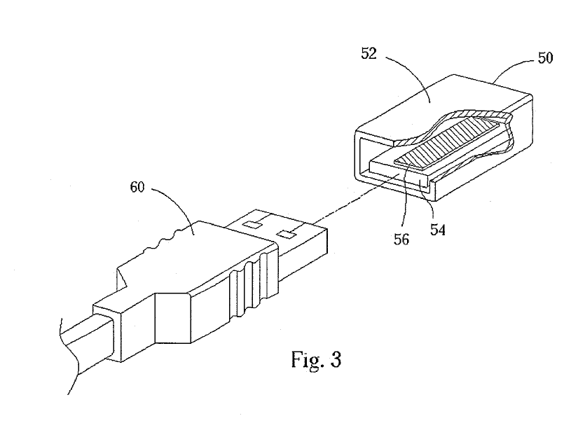

Additional operational modes of a USB device can be accomplished by use of a specially-designed USB port terminator. Please refer to FIG. 3, which is a perspective view of a cap terminator 50 according to the present invention, and a male USB device port 60. The terminator 50 comprises an outer shell 52 with an inner tongue 54. Both the shell 52 and the tongue 54 are made from an electrically nonconductive material, such as the commonly available thermoplastics PBT or PET. Disposed on the tongue 54 is an electrical contact 56, which can be a typical gold plated copper USB grade conductor. The contact 56 is positioned in such a way that when the terminator is mechanically mated with the USB device port 60, the contact 56 connects the D+ and D− signal lines to the ground line of the USB device port 60. The outer shell 52 and tongue 54 of the terminator 50 are designed such that misconnection to the USB device port 60 is impossible. Of course, the VBUS and ground lines must not be shorted together by the terminator 50.

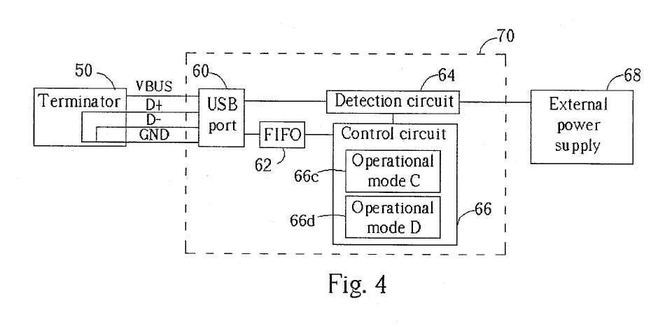

A block diagram of a present invention USB device 70 with the terminator 50 connected via the male USB port 60 is illustrated in FIG. 4. The device 70 further comprises a FIFO 62, a detection circuit 64, and a control circuit 66 all interconnected in the same manner as the previously described for the USB device 30 in FIG. 2. As it can be readily seen, the contact 56 of the terminator 50 essentially shorts the USB port signal lines D+ and D− to the ground line GND.

Suppose that the USB device 70 is an externally powered ink jet printer with a single male USB device port for connecting to a host PC. The printer has two operational modes C 66c and D 66d, mode C 66c being a standard printing mode, and mode D 66d being a factory test mode. An external power supply 68 is connected to the USB device 70 and provides all the operating power required by the device 70.

After manufacture, the printer device 70 is to be tested. Firstly, the terminator 50 is installed and the device 70 is powered up. The detection circuit 64, not detecting a voltage on the power line VBUS of the port 60, informs the control circuit 66 that the device 70 is not connected to a host. Then the device 70 generates a short pull-high pulse on signal lines D+ or D− and the detection circuit 64 detects the signals are now grounded, and consequently prompts the control circuit 66 to enter operational mode D 66d, the factory test mode. The printer device 70 is then tested by the test operator, and at this time, factory default settings may be set. On the other hand, if the terminator 50 is left uninstalled after power up, the detection circuit 64 detects the signals are not grounded. The control circuit 66 accordingly puts the device 70 into user mode C 66c on a standby status, waiting to be connected to a host PC. The terminator 50 is thus used to switch the device 70 into a nonuser mode D 66d for manufacturing and testing purposes.

It should be noted that the device 70 could be a high-speed, full-speed, or low-speed USB device as the terminator 50 grounds both the signal lines D+ and D−. Alternatively, the terminator 50 could be designed to ground only the signal line D+ for high-speed or full-speed connections, or ground only the signal line D− for a low-speed connection.

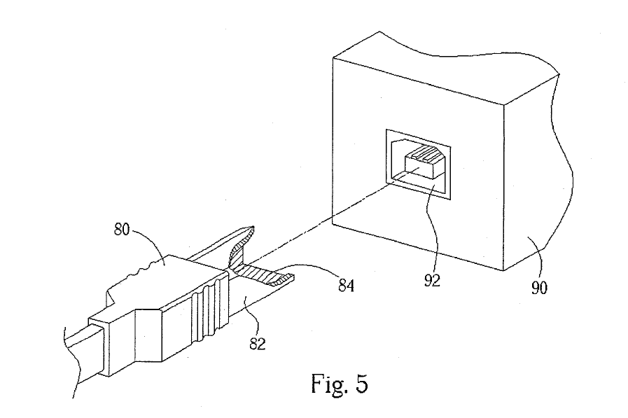

The concept of the terminator 50 can be logically extended. Multiuse terminators could be designed that, rather than shorting the USB signal lines to ground, provide a resistance or other measurable electrical characteristic between the lines of the USB device port. In addition, the terminator could be connected to and removed from one or more USB ports of the USB device following a specific procedure. Moreover, the terminator could also be a plug type connector for use in a female USB device port. Please refer to FIG. 5, which shows a USB device 90, comprising a standard type B device port 92, being fitted with an alternative terminator 80. The terminator 80 comprises a nonconductive body 82, which can have a metal-sheathed outer surface. The body 82 has a cavity on the inside of which is disposed an electrical contact 84. The contact 84 is placed in such a way that when the terminator 80 is mechanically mated with the device port 92, the D+ and D− signal lines are connected to the ground line of the device port 92. As with the previously described terminator 50, the terminator 80 cannot mate with the device port 92 in an incorrect orientation, and does not affect the voltage contact VBUS of the device port 92. These possible variations of the terminator still simply allow it to fulfill its main purpose, that of USB device mode changing.

The two examples of the USB devices described previously were provided for clarity, and should not be taken as limiting. For example, a terminator is easily applied to the host-to-host combination storage device to facilitate a test mode, while simultaneously protecting the unused USB port from dust and debris. Numerous operational modes can be realized by the present invention by applying the detection method described and by various combinations of host, terminator, and unconnected port on the USB device.

Generally, the multifunction USB device can have any number of USB device ports, and can be powered by a host or by a separate power supply. The status of each port is monitored by the detection circuit in the device with respect to host provided voltage level VBUS and signal line D+ and D− level. Each device port can be connected to a host PC, a terminator, or can be left unconnected with the status of the device port set accordingly. Depending on the status of the device ports, the USB device is controlled by the control circuit to enter a given operational mode. The operational mode is finalized by a function reset. Essentially, the present invention in this preferred embodiment offers a multifunction USB device capable of switching modes so that each host PC considers each mode to be a unique device.

In contrast to the prior art, the present invention automatically changes the operational mode of a USB device depending on whether the port or ports of the USB device are unconnected, connected to a host PC, or connected to a terminator. The present invention mode switching is more convenient for the user. The present invention mode selection method can also make available less expensive multifunction USB devices, having less FIFOs than in the prior art.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A terminator for a universal serial bus (USB) port, the USB port comprising:
a D− signal line;
a D+ signal line; and
a ground line;
the terminator comprising:
an electrically non-conductive member adapted for mechanically mating with the USB port; and
at least an electrical contact disposed on a surface of the electrically non-conductive member for electrically tying the D− line or the D+ line to the ground line.

2. The terminator of claim 1 wherein the electrically non-conductive member is a cap and the USB port is a male USB port.

3. The terminator of claim 1 wherein the electrically non-conductive member is a plug and the USB port is a female USB port.

4. A mode switching method for a universal serial bus (USB) device, the method comprising:
providing power to the USB device;
detecting whether the D− line or the D+line of a USB port of the USB device is grounded; and
switching the operational mode of the USB device, the USB device entering into a predefined mode when the D− line or the D+ line of the USB port is grounded.

5. The method of claim 4, wherein the predefined mode is a test mode of the USB device.

6. The method of claim 4, further comprising:
having the terminator of claim 1 mate with the USB port of the USB device.

7. The method of claim 4, wherein power is provided to the USB device either from a USB host or from a separate power supply.

8. A mode switching method for a universal serial bus (USB) device, the method comprising:
providing power to the USB device;
providing a detection circuit for detecting when a first USB port of the USB device is electrically connected to a first USB host and for detecting when a second USB port of the USB device is electrically connected to a second USB host;
providing a USB control circuit for setting an operational mode of the USB device according to the detection circuit, the USB control circuit supporting at least a first operational mode and a second operational mode;
the USB control circuit entering into the first operational mode when the detection circuit determines that the first USB port is electrically connected to the first USB host and the second USB port is not electrically connected to the second USB host; and
the USB control circuit entering into the second operational mode when the detection circuit determines that the first USB port is electrically connected to the first USB host and the second USB port is electrically connected to the second USB host.

9. The method of claim 8 wherein the detection circuit utilizes a USB VBUS line in the first USB port to determine electrical connectivity to the first USB host, and utilizes a USB VBUS line in the second USB port to determine electrical connectivity to the second USB host.

10. The method of claim 8, further comprising:
providing shared FIFOs for the first operational mode and the second operational mode between the USB control circuit and the first USB host and the second USB host.

11. The method of claim 8, further comprising
detecting whether the D− line or the D+ line of a USB port of the USB device is grounded; and
switching the operational mode of the USB device, the USB device entering into a third operational mode when the D− line or the D+ line of the USB port is grounded.

12. The method of claim 8, further comprising
having the terminator of claim 1 mate with a USB port of the USB device; and
switching the operational mode of the USB device, the USB device entering into a third operational mode when the terminator of claim 1 is mating with the USB port.

13. The method of claim 8, wherein power is provided to the USB device either from a USB host or from a separate power supply.
